(19) United States
(12) Patent Application Publication
(10) Pub. No.: US 2026/0275779 A1
(43) Pub. Date: Sep. 17, 2026

(54) MOTOR VEHICLE LOCKING DEVICES

(71) Applicant: Kiekert Aktiengesellschaft, Heiligenhaus (DE)

(72) Inventors: Ömer INAN, Dorsten (DE); Peter SZEGENY, Engelskirchen (DE); Holger SCHIFFER, Meerbusch (DE); Michael SCHOLZ, Essen (DE); Andreas SCHMITZ, Velbert (DE); Thorsten BENDEL, Oberhausen (DE)

(73) Assignee: Kiekert Aktiengesellschaft, Heiligenhaus (DE)

(21) Appl. No.: 19/167,996

(22) PCT Filed: Apr. 26, 2024
(86) PCT No.: PCT/DE2024/100376

§ 371 Date: Sep. 23, 2025

(30) Foreign Application Priority Data
May 11, 2023 (DE) 10 2023 112 450.1

(51) Int. Cl. E05B 85/24; E05B 77/10

(52) U.S. Cl. CPC E05B 85/243; E05B 77/10

(57) ABSTRACT

A motor vehicle locking device, in particular a motor vehicle lock and preferably a motor vehicle door lock. The locking device is made of a locking mechanism which is mounted in or on a lock plate and consists, essentially, of a rotary latch and a pawl. The rotary latch has a contact arm, a load arm, and an inlet opening which is provided between the two arms for receiving a lock mounting. Furthermore, a support element which is connected to the lock plate is provided for transmitting forces acting on the lock mounting, which is caught by the rotary latch in the locked state, to the lock plate via the rotary latch. According to the invention, the load arm of the rotary latch is supported against the support element. Alternatively, a protrusion which is connected to the rotary latch can also be supported against the support element

The invention relates to a motor vehicle locking device, in particular a motor vehicle lock and preferably a motor vehicle door lock, with a locking mechanism which is mounted in or on a lock plate and consisting, substantially, of a rotary latch and a pawl, wherein the rotary latch has a contact arm, a load arm, and an inlet opening which is provided between the two arms for receiving a lock mounting, and with a support element which is connected to the lock plate for transmitting forces acting on the lock mounting, which is caught by the rotary latch in the locked state, to the lock plate via the rotary latch.

The term “motor vehicle locking device” is generally understood to mean any device for locking, for example, a tailgate in or on a motor vehicle. In particular, it refers to a motor vehicle lock, and preferably a motor vehicle door lock, with the aid of which motor vehicle doors, such as side doors but also motor vehicle tailgates, are locked against a motor vehicle body. For this purpose, the locking mechanism, which consists, essentially, of a rotary latch and pawl, interacts on the lock side with the lock mounting provided on the body side.

For this purpose, the lock mounting is caught and held in the inlet opening of the rotary latch when the locking mechanism is in the locked state. If an accident occurs in the locked state, so-called tear forces act on the lock mounting, which can act in the direction to cause the locking mechanism or rotary latch to open.

To prevent this, the locking engagement of the pawl in the rotary latch ensures that such unintentional openings are avoided. Since the acting tear forces are often very high and can amount to several kN, attempts have already been made in the prior art to additionally absorb the forces transmitted from the lock mounting to the rotary latch and to transfer them to the lock plate. The invention is based on the knowledge that the lock plate is typically connected to the associated motor vehicle door and can therefore be used in conjunction with the rotary latch to absorb such tear forces.

First and foremost, it is therefore crucial that the rotary latch and the pawl do not deform when such tear forces occur. This is taken into account by a particularly solid design and the use of mostly high-strength steels as materials. Furthermore, the support element provided in the generic prior art ensures that the forces transmitted to the rotary latch via the lock mounting are not only transferred to the lock plate by a bearing mandrel supporting the rotary latch, but also that the support element connected to the lock plate is configured and designed to transmit these forces.

This means that the forces transmitted from the lock mounting, which is caught by the rotary latch, to the rotary latch when the locking mechanism is in the locked state are, within the scope of the generic teaching, not only transmitted via the rotary latch to the lock plate and thus ultimately to the motor vehicle door, but also from the rotary latch to the lock plate via the support element.

For this purpose, the generic prior art according to DE 10 2020 106 592 A1 proceeds in such a way that the lock plate has said support element, referred to as the counter element, or the support element which is connected to the lock plate and interacts with a support element as an engagement recess on the rotary latch. This means that in this case the rotary latch has the engagement recess already mentioned, into which the support element connected to the lock mounting engages when the locking mechanism is in the locked state. The engagement recess is located in or on the contact arm of the rotary latch and, moreover, is remote from the axis compared to a bearing bolt that supports the rotary latch relative to the lock case.

This requires a special design of the contact arm and the formation of the engagement recess on or in the contact arm. As a result, the rotary latch with the contact arm in the generic teaching according to DE 10 2020 106 592 A1 is relatively expansive and extends, with the contact arm including the engagement recess for the support element, far into the motor vehicle lock, opposite an inlet slot in the lock plate through which the lock mounting enters the motor vehicle lock when the associated motor vehicle door is closed. Such a relatively expansive design is disadvantageous in terms of material consumption, for example, for the lock plate. On the other hand, a shallow installation depth is required for motor vehicle locking devices, and in particular motor vehicle locks, because the associated motor vehicle door is additionally equipped with additional features such as side airbags, window regulators, impact protection, loudspeakers, possibly additional drives, etc.

This means that the generic teaching according to DE 102020 126592 A1 is disadvantageous with regard to a compact embodiment and requires special adaptation measures for the rotary latch on the contact arm to create the engagement recess for the support element. This is disadvantageous considering cost-effective production and compact dimensions. This is where the invention steps in.

The invention is based on the technical object of further developing such a motor vehicle locking device, and in particular a motor vehicle lock, in such a way that, while achieving a compact design and low construction and financial expenditure, tear forces can still be controlled, in particular in the event of a crash.

To achieve this technical object, the invention proposes, in the scope of a first variant of a generic motor vehicle locking device, that the load arm of the rotary latch is supported against the support element.

In this case, the invention—in contrast to the generic prior art according to DE 10 2020 106 592 A1—proceeds in such a way that the load arm of the rotary latch is supported against the support element, whereas in the generic prior art, which represents the starting point, the contact arm interacts with the support element.

The invention is based on the knowledge that, as a rule and when the locking mechanism is in the locked state, the lock plate already has a certain amount of free space at the edge of the inlet slot of the lock plate or its opening, which can be used to receive the support element. Thus, the attachment of the support element does not change the basic dimensions of the motor vehicle locking device. At the same time, said free space on the edge of the inlet slot of the lock plate or its opening between an edge of the lock plate and the contact arm of the rotary latch when the locking mechanism is in the locked state can be advantageously used for the placement of the support element, so that the support element can interact directly with the contact arm of the rotary latch in this region.

This supports and prevents any movement of the contact arm of the rotary latch towards this free space. Such movements can be caused by tear forces acting on the lock mounting in the opening direction of the locking mechanism, as already described in the introduction. In this context, the design is usually also such that the support element in question is positioned remote from the axis of the rotary latch. Consequently, with the aid of the support element, high torques acting on the rotary latch in the opening direction can be absorbed and ultimately transmitted to the motor vehicle door or motor vehicle tailgate supporting the lock mounting via the lock mounting.

In an alternative embodiment of the invention within the scope of a second variant, the procedure is such that a protrusion connected to the rotary latch is supported against the support element in order to achieve the technical object based on the generic teaching. The protrusion connected to the rotary latch can be connected to the load arm or the contact arm. In most cases, the protrusion and the rotary latch form a single piece. In this case, the rotary latch, including the protrusion, is manufactured as a stamped component. In general, however, it is also possible for the protrusion to be coupled to the rotary latch using conventional joining techniques such as welding.

In this context, it has proven particularly advantageous to position the support element close to the axis of the rotary latch. This allows the design to be such that the protrusion connected to the rotary latch does not result in an enlargement of the lock housing or lock plate compared to the alternative situation where a rotary latch without a protrusion is used. This means that the advantageous attachment of the support element close to the axis automatically ensures that the protrusion on the rotary latch does not correspond to any protruding features of the rotary latch, including the protrusion, and consequently, a compact design is still observed overall.

Furthermore, it has proven particularly advantageous in this context if the support element interacting with the protrusion is connected to the lock plate in the extension of the axis of the rotary latch or beyond the axis of the rotary latch opposite the contact arm, when the locking mechanism is in the locked state. In this case, the invention is based on the further finding that in the region in the extension of the axis of the rotary latch or beyond the axis of the rotary latch, opposite the contact arm, there is again free space on or at the lock plate, which can be used for the attachment of the support element without requiring any extensive modifications or compromising the compactness of the motor vehicle locking device.

The extension of the axis of the rotary latch refers to a direction or viewing direction that the lock mounting follows as it enters the inlet slot of the lock plate to lock the locking mechanism. In fact, according to the invention, in the direction of an extension of the axis of the rotary latch in this direction of entry of the lock mounting, there is a free space close to the axis because the circular arc-shaped region of the rotary latch surrounding the axis of the rotary latch is set back relative to the adjoining contact arm. This free space can now be used according to the invention for attaching the support element to the lock mounting. The same applies to the free space, which is also observed, which is located or observed beyond the extension of the axis of the rotary latch and opposite the contact arm of the rotary latch on the lock plate and can be used alternatively for the attachment of the support element. In the latter case, the support element interacts with a protrusion on the load arm of the rotary latch, whereas the former variant, with the support element attached in extension of the axis of the rotary latch, corresponds to the protrusion being connected to the contact arm of the rotary latch.

All of the variants presented can be advantageously further developed by forming the support element integrally with the lock plate, for example, as an embossing, bracket tab, bevel, bead, pull-through etc. This means that in this case, a separate and additional attachment of the support element to the lock plate is not necessary. Rather, the support element is integrated into the manufacturing process of the lock plate. In the case of embossing, it is conceivable that the lock plate is embossed in the region of the support element using an embossing tool and, for example, has a projection which assumes the function of the support element.

Alternatively, a bending process can be integrated into the manufacturing process to create a bending tab or bracket tab, a bevel or bead, or to create a pull-through. This keeps the manufacturing costs for the lock plate, including the support element, particularly low, while ensuring that the support element has comparable strength to the lock plate itself.

Alternatively, the support element can also be designed separately from the lock case or the lock plate. In this case, the support element is, for example, a screw or a pin which is screwed, riveted or otherwise connected to the lock plate.

A third alternative provides for the support element to be designed as a component of a functional component. In this case, the support element is designed as a component of the functional component or can also coincide with the functional component. The functional component performs a dual function in that, in addition to its original function, it also supports the rotary latch against tear forces.

For example, the support element may be a stepped mandrel for supporting an additional reinforcement plate. Such a reinforcement plate is often used to provide additional stiffening to the locking mechanism. For this purpose, the reinforcement plate is usually arranged parallel to and spaced from the lock plate and serves to connect the axes of the rotary latch and usually also the pawl to one another via the reinforcement plate, in addition to the lock plate. For this purpose, corresponding bearing mandrels, which serve as the axis for the rotary latch and the pawl, penetrate both the lock plate and the reinforcement plate and serve to couple them together.

Such a reinforcement plate is usually additionally held at a distance from the lock plate by one or more stepped mandrels. This stepped mandrel, as a functional component, namely for holding the reinforcement plate, now assumes an additional function according to the invention as a support element for the rotary latch, in order to transmit the tear forces acting on the rotary latch to the lock plate.

Another functional component can be a lock housing, which is usually used to cover the lock plate and seal it against environmental influences. In addition to this function, the housing, as a functional component, can also function as a support element for the rotary latch. For this purpose, the housing may, for example, be equipped with a reinforcement plate to provide the desired functionality as a support element. In this case, the reinforcement plate on the lock housing assumes the function of the support element and thus represents a component of the functional component, namely the lock housing.

In this context, it is also fundamentally possible for the functional component in question to be designed integrally with the support element, for example, to have an embossing, a bracket tab, a bevel, etc., or to be designed as such, as already described at the outset.

Finally, it has proven advantageous in favor of a compact design if the support element is arranged on or adjacent to the outer circumference of the rotary latch. This advantageously utilizes the free space often already available on the outer circumference of the rotary latch for the attachment of the support element. These are the main advantages.

The invention is explained in greater detail below with reference to drawings which show only one exemplary embodiment. In the drawings:

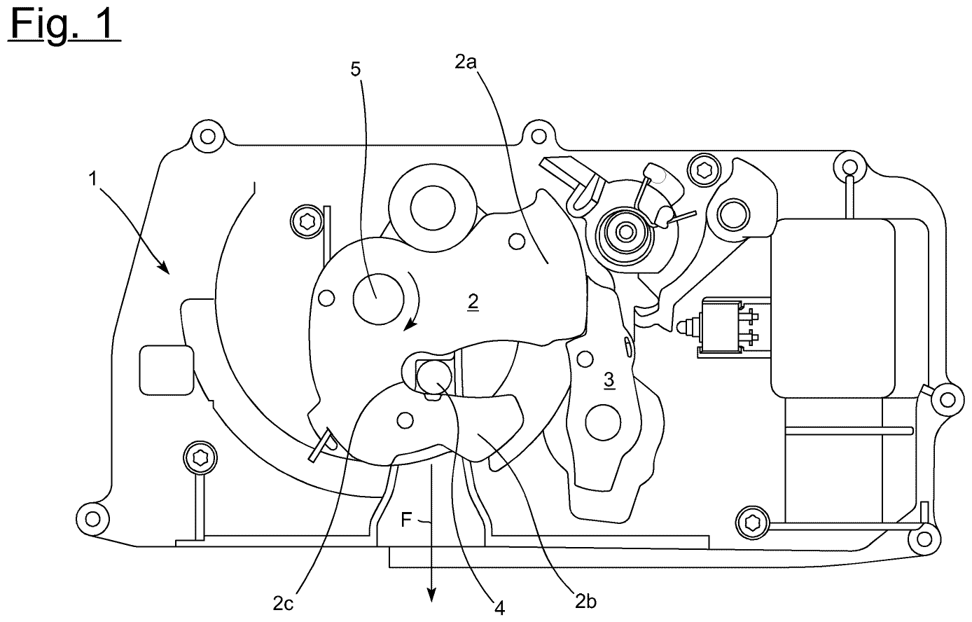

FIG. 1 shows a motor vehicle locking device in the form of a motor vehicle lock according to the prior art,

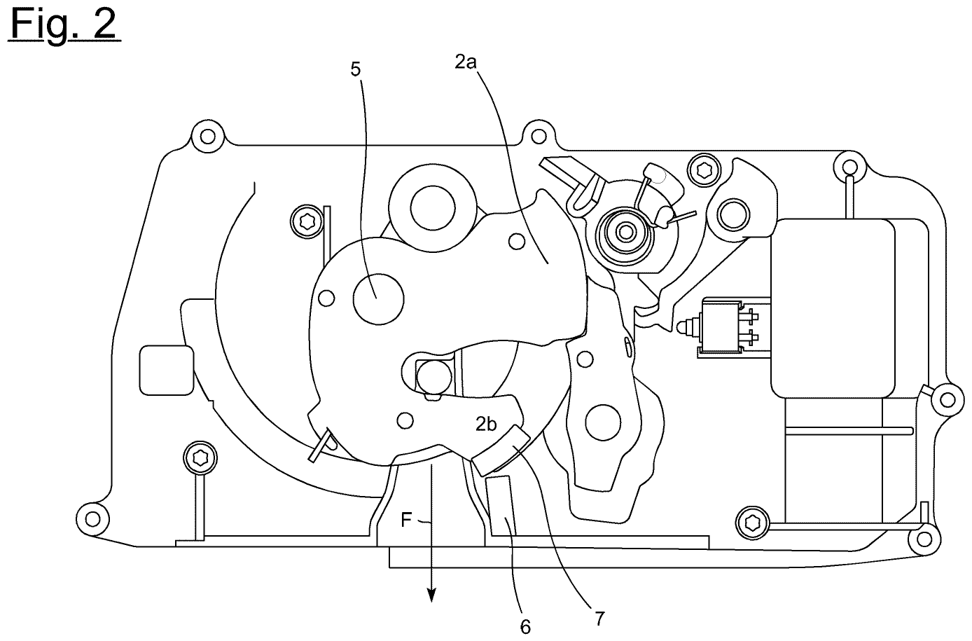

FIG. 2 shows a motor vehicle locking device according to the invention, in which the load arm of the rotary latch is supported against the support element in a first variant,

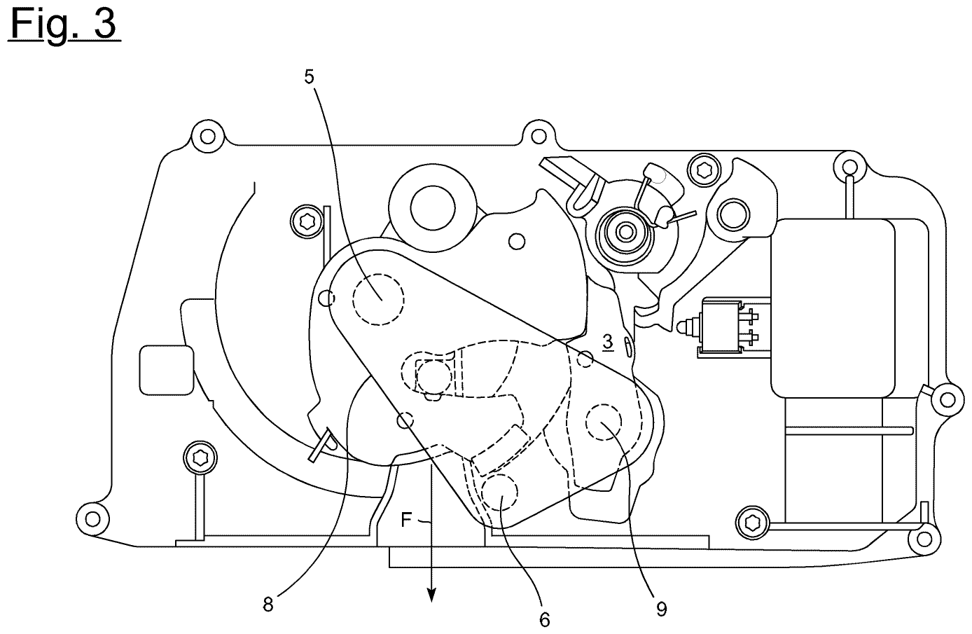

FIG. 3 shows a second variant in accordance with FIG. 2,

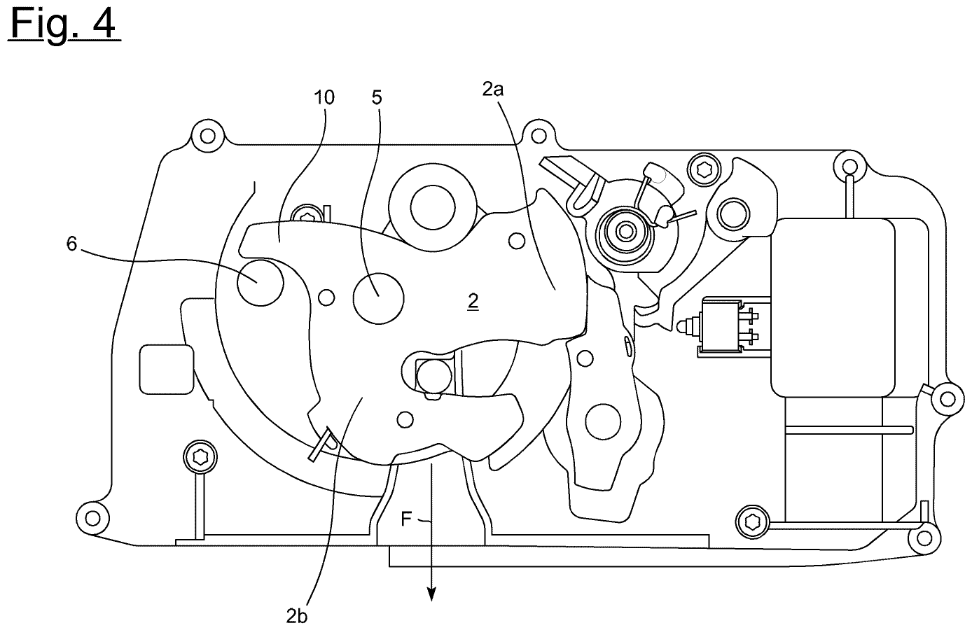

FIG. 4 shows an alternative embodiment of the invention, in which a protrusion connected to the rotary latch is supported against the support element in a first variant,

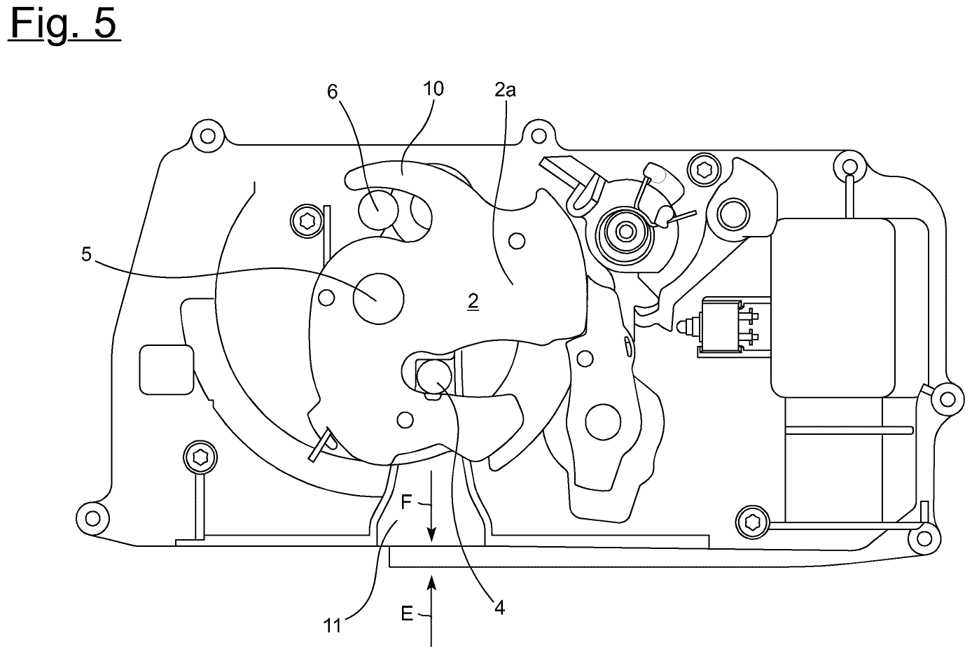

FIG. 5 shows the exemplary embodiment according to FIG. 4 in a further second variant.

In the drawings, a motor vehicle locking device is shown. In its basic design, this device comprises a lock plate 1 and a locking mechanism 2, 3 which is mounted on the lock plate 1 and consists, substantially, of a rotary latch 2 and a pawl 3. According to the exemplary embodiment, the motor vehicle locking device is designed as a motor vehicle lock, specifically a motor vehicle door lock. In principle, the locking mechanism 2, 3 can also be designed with two pawls 3 instead of the single pawl 3 shown here.

The rotary latch 2 is equipped with a contact arm 2a and a load arm 2b. Between both arms 2a, 2b there is an inlet opening 2c which serves to receive a lock mounting 4. According to the illustration in FIG. 1, tear forces F can act on the lock mounting 4 in the direction of the arrow shown there, in particular in the event of a crash, and ensure that the rotary latch 2 is acted upon in the opening direction, i.e., in the clockwise direction indicated in FIG. 1 with respect to an axis 5 of the rotary latch 2. In the prior art according to FIG. 1, this is prevented by the pawl 3, which holds the rotary latch 2 in locking engagement.

Additionally, and according to the invention, a support element 6 is now connected to the lock plate 1, which can have different configurations as shown in FIGS. 2 and 3. With the aid of the support element 6, the tear forces F acting on the lock mounting 4 are absorbed. In fact, these forces or tear forces F acting on the lock mounting 4 result in them being transferred to the rotary latch 2 via the lock mounting 4 when the locking mechanism is in the locked state 2, 3. The rotary latch 2, in turn, transmits these forces to the lock plate 1 via a bearing mandrel 5 defining the axis 5 and additionally via the support element 6, which, like the bearing mandrel 5, is also connected to the lock plate 1.

It can be seen from FIGS. 2 and 3 that, for this purpose, the load arm 2b of the rotary latch 2 is supported against the support element 6 in question. For this purpose, the load arm 2b in question may be equipped with an extension 7, as indicated in FIGS. 2 and 3. However, this is not mandatory. In this case, namely the support of the load arm 2b of the rotary latch 2 against the support element 6, the support element 6 is arranged entirely remote from the axis compared to the axis 5 of the rotary latch 2, so that with the aid of the support element 6, large tear forces F acting on the rotary latch 2 in the opening direction can be absorbed.

In this case, the support element 6 is formed integrally with the lock plate 1 in the scope of the variant according to FIG. 2. In fact, the support element 6 in the present case is a bevel or bending tab which is incorporated into the lock plate 1 during the manufacturing process of the lock plate 1. In the variant according to FIG. 3, the support element 6 is formed separately from the lock plate 1. In fact, in this case it could be a screw or a pin.

The variant additionally indicated in FIG. 3 is particularly advantageous in that the support element 6 is designed as a component of a functional component. In fact, the variant according to FIG. 3 is a stepped mandrel, which serves to support a reinforcement plate 8 (only indicated here) on the lock plate 1. For this purpose, the reinforcement plate 8 is arranged largely parallel to and spaced from the lock plate 1 and connects both the axis 5 of the rotary latch 2 and an axis 9 of the pawl 3, or the bearing mandrels 5, 9 provided at this location, to one another and to the stepped mandrel or support element 6.

The exemplary embodiments according to FIGS. 4 and 5 now utilize an additional protrusion 10 on the rotary latch 2, which in turn is supported against the support element 6. In the illustration according to FIGS. 4 and 5, the support element 6 can again be designed integrally with the lock plate 1 or separately from the lock plate 1. In addition, the support element 6 can be designed as a component of a functional component or as a functional component itself, as has already been described above with reference to FIG. 3 and the stepped mandrel provided at this location for holding the reinforcement plate 8 as the support element 6.

The protrusion 10 can be formed integrally with the rotary latch 2 or as a separate component to be connected to the rotary latch 2. Furthermore, in the variant according to FIG. 4, the protrusion 10 is connected to the load arm 2b, whereas the variant according to FIG. 5 is designed such that in this case the protrusion 10 is connected to the contact arm 2a of the rotary latch 2.

It can be seen that in the variant according to FIG. 5, the support element 6 interacting with the protrusion 10 is arranged in extension of the axis 5 of the rotary latch 2. In fact, the extension of the axis 5 of the rotary latch 2 coincides with an insertion direction E of the lock mounting 4 into an inlet slot 11 of the lock plate 1, indicated by an arrow in FIG. 5, or the extension of the axis 5 is to be carried out in a direction parallel thereto. The insertion direction E is predominantly oriented opposite to the tear force F. Furthermore, in the variants according to FIGS. 4 and 5, the support element 6 is arranged close to the axis compared to the axis 5 of the rotary latch 2.

This is possible because, in the extension of the axis 5 of the rotary latch 2 in the insertion direction E of the lock mounting 4, there is a free space with respect to the lock plate 1, close to the axis compared to the respective axis 5, which is used according to the invention for the attachment of the support element 6 there. This free space is created because an arc-shaped region of the rotary latch 2 in the region of its axis 5 springs back relative to the contact arm 2a when the locking mechanism is in the locked state 2, 3.

In the variant according to FIG. 4, the support element 6 is located beyond the axis 5 of the rotary latch 2 or the extension of the axis 5 in the insertion direction E, specifically opposite the contact arm 2a of the rotary latch 2 on the lock plate 1. In this region, close to the axis 5 of the rotary latch 2, a free region is generally provided on or at the lock plate 1, which is advantageously used according to the invention for the attachment of the support element 6.

In all described embodiments, the overall design is such that the support element 6 is arranged on or adjacent to the outer circumference of the rotary latch 2. Furthermore, the support element 6 can be realized and implemented taking into account the three described variants, namely integrally with the lock plate 1, separately and apart from the lock plate 1, or as a component of a functional component or as a functional component itself, as is the case for the stepped mandrel of the reinforcement plate 8.

### LIST OF REFERENCE SIGNS

Lock plate 1
Locking mechanism 2, 3
Rotary latch 2
Contact arm 2a
Load arm 2b
Inlet opening 2c
Pawl 3
Lock mounting 4
Axis, bearing mandrel 5
Support element 6
Extension 7
Reinforcement plate 8
Axis 9
Bearing mandrels 9
Protrusion 10
Inlet slot 11
Insertion direction E
Tear forces F

1. A motor vehicle locking device, in particular a motor vehicle lock and preferably a motor vehicle door lock, with a locking mechanism which is mounted in or on a lock plate and consisting, substantially, of a rotary latch and a pawl, wherein the rotary latch has a contact arm, a load arm, and an inlet opening which is provided between the two arms for receiving a lock mounting, and with a support element which is connected to the lock plate for transmitting forces acting on the lock mounting, which is caught by the rotary latch in the locked state, to the lock plate via the rotary latch,
wherein
the load arm of the rotary latch is supported against the support element.

2. The device according to claim 1, wherein the support element is arranged remote from the axis of the rotary latch.

3. A motor vehicle locking device, in particular a motor vehicle lock and preferably a motor vehicle door lock, with a locking mechanism which is mounted in or on a lock plate and consisting, substantially, of a rotary latch and a pawl, wherein the rotary latch has a contact arm, a load arm, and an inlet opening which is provided between the two arms for receiving a lock mounting, and with a support element which is connected to the lock plate for transmitting forces acting on the lock mounting, which is caught by the rotary latch in the locked state, to the lock plate via the rotary latch,
wherein
a protrusion which is connected to the rotary latch is supported against the support element

4. The device according to claim 3, wherein the protrusion is connected to the load arm or the contact arm.

5. The device according to claim 3, wherein the support element interacting with the protrusion is connected to the lock plate in the extension of an axis of the rotary latch or beyond the axis opposite the contact arm.

6. The device according to claim 1, wherein the support element is formed integrally with the lock plate, for example as an embossing, bending tab, bevel, bead or pull-through.

7. The device according to claim 1, wherein the support element is formed separately from the lock plate, for example as a screw or pin.

8. The device according to claim 1, wherein the support element is designed as a component of a functional component or as a functional component itself, for example as a stepped mandrel for supporting a reinforcement plate or as a component of a housing with a reinforcement plate.

9. The device according to claim 1, wherein the support element is arranged on or adjacent to the outer circumference of the rotary latch.

10. The device according to claim 1, wherein the support element is arranged close to the axis of the rotary latch.
